(19) United States
(12) Patent Application Publication
(10) Pub. No.: US 2006/0036055 A1
(43) Pub. Date: Feb. 16, 2006

(54) Organopolysiloxane/polyurea/polyurethane block copolymers

(75) Inventors: Oliver Schafer, Burghausen (DE); Franz Csellich, Unterhaching (DE); Sabine Delica, Munchen (DE); Andrea Kneissl, Ottobrunn (DE)

Correspondence Address: BROOKS KUSHMAN P.C., 1000 TOWN CENTER, TWENTY-SECOND FLOOR, SOUTHFIELD, MI, 48075, US

(73) Assignee: Consortium fur elektrochemische Industrie GmbH, Munchen (DE)

(21) Appl. No.: 11/235,613

(22) Filed: Sep. 26, 2005

Related U.S. Application Data
(63) Continuation of application No. PCT/EP04/02532, filed on Mar. 11, 2004.

(30) Foreign Application Priority Data
Mar. 27, 2003 (DE) 103 13 936.2

(51) Int. Cl. C08G 18/00

(52) U.S. Cl. 528/44

(57) ABSTRACT

Organopolysiloxane/polyurea/polyurethane block copolymers of general formula (1) B—{[NR⁴—CR₂—SiR₂—(O—SiR₂)ₙ—CR²₂—NR⁴—CO—NH—Y—NH—CO]ₐ-[Z-D-Z-CO—NH—Y—NH—CO]_{b}—[NR⁴—CR₂₂—SiR₂—(O—SiR₂)ₙ—CR²₂—NR⁴—CO—NH—Y—NH—CO—NH—Y—NH—CO]ₑ}_{d}—B, are obtained by reacting aminomethyl terminal polydimethyl siloxanes with diisocyanates and optional chain extenders, have low softening temperatures and reduced color.

### CROSS-REFERENCE TO RELATED APPLICATIONS

This application is a continuation of PCT application Ser. No. PCT/EP2004/002532, filed Mar. 11, 2004, which claims the benefit of German Application No. 103 13 936.2, filed Mar. 27, 2003.

### BACKGROUND OF THE INVENTION

1. Field of the Invention

The invention relates to organopolysiloxane/polyurea/polyurethane block copolymers of the general formula (1)
B—{[NR⁴—CR²₂—SiR₂—(O—SiR₂)ₙ—CR²₂—NR⁴—COH—NH—Y—NH—CO]ₐ-[Z-D-CO—NH—Y—NH—CO]_{b}—[NR⁴—CR²₂—SiR₂—(O—SiR₂)ₙ—CR²₂—NR⁴—CO—NH—Y—NH—CO—NH—Y—NH—CO]_{c})_{d}—B,
obtained from the reaction of aminomethyl-terminated polydimethylsiloxanes with diisocyanates and, if desired, chain extenders, to a process for preparing them, and to their use.

2. Background Art

The properties of polyurethanes and silicone elastomers are complementary in wide ranges. Polyurethanes are notable for their outstanding mechanical strength, elasticity, and very good adhesion, abrasion resistance, and ease of processing by extrusion from the melt. Silicone elastomers, on the other hand, possess excellent temperature, UV, and weathering stability. They retain their elastic properties at relatively low temperatures and consequently do not tend toward embrittlement either. In addition they possess special water repellency and antistick surface properties.

Accordingly the combination of urethane polymers and silicone polymers ought to provide access to materials having good mechanical properties, which at the same time feature processing possibilities which are greatly simplified as compared with the silicones, while continuing to possess the positive properties of the silicones. The combination of the advantages of both systems can therefore lead to compounds having low glass transition temperatures, low surface energies, improved thermal and photochemical stabilities, low water absorption, and physiologically inert materials.

Adequate compatibilities have been achieved in only a few specific cases through the production of simple polymer blends. Not until the preparation of polydiorganosiloxane-urea block copolymers, described in I. Yilgör, Polymer, 1984 (25), 1800 and in EP-A-250248, was it possible to achieve this objective. The reaction of the polymer building blocks takes place ultimately by a comparatively simple polyaddition, such as is employed for the preparation of polyurethanes. As starting materials for the siloxane-urea copolymers, aminopropyl-terminated polysiloxanes were used as siloxane building blocks. They formed the soft segments in the copolymers, similarly to the polyethers in pure polyurethane systems. Hard segments used were common diisocyanates, which may also be modified by adding diamines, such as 1,6-diaminohexane, or dihydroxy compounds, such as butanediol, for example, in order to attain higher strengths. The reaction of the amino compounds with isocyanates is spontaneous and as a general rule requires no catalyst.

The silicone and isocyanate polymer building blocks are readily miscible within a wide range. The mechanical properties are determined by the proportion of the different polymer blocks—soft silicone segments and hard urea segments—and, critically, by the diisocyanate used. As a result of the strong interactions of the hydrogen bonds between the urea units, thermoplastic materials are obtained. The preparation can be carried out batchwise in solution or else continuously as described for example in European patent EP 0 822 951.

Both in Yilgör et al. and also in European patents EP 0 250 248 and EP 0 822 951 the aminopropyl-functional siloxanes used as starting material are prepared by way of equilibration reactions from siloxane rings and bisaminopropyltetramethyldisiloxane. The difunctional silicone oils prepared via these equilibration reactions, however, have a number of drawbacks.

The equilibration reaction described in EP 0 250 248 is a very protracted reaction in which, moreover, it is necessary to use a very expensive starting material such as bisaminopropyltetramethyldisiloxane and specific catalysts, which have to be synthesized as an extra. This is not economically feasible. Furthermore, in the equilibration reaction, relatively large amounts of preferably between 500 and 1000 ppm of catalyst are employed. At the end of the equilibration reaction the catalyst is thermally deactivated, leading to degradation products and hence to impurities in the end product, which have consequences for the thermal stability of the materials thus produced. During the thermal treatment the silicone oils thus prepared display a tendency to take on a markedly visible discoloration in the form of a yellow tint. These degradation products are likewise responsible for the strong intrinsic odor of the materials synthesized therefrom. This intrinsic odor is markedly perceptible and leads, furthermore, to instances of irritation to the user or processor of these materials.

The materials produced in accordance with EP 0 822 951 generally have softening ranges above 100° C., which in the case of use, for example, as a hot-melt adhesive or matrix material for moisture-crosslinking siloxane materials would necessitate application temperatures of well above 120° C., which in some cases cannot be achieved with common hot-melt metering systems, or else is too hot for plastics parts that are to be bonded, on account of the fact that said parts then begin themselves to melt.

### SUMMARY OF THE INVENTION

The object was therefore to prepare organopolysiloxane/polyurea/polyurethane block copolymers which exhibit a markedly reduced yellow tint and do not give off irritants. Furthermore, the copolymers ought to soften at below 100° C. and hence ought to have a processing temperature of below 100° C.

Thee and other objects have surprisingly been achieved through the use, as starting material for the preparation of the copolymers, of bisaminomethyl-terminated siloxanes, which are available in very good purity without the addition of catalysts.

### DETAILED DESCRIPTION OF THE PREFERRED EMBODIMENTS

The invention accordingly provides organopolysiloxane/polyurea/polyurethane block copolymers of the general formula (1)
B—{[NR⁴—CR²₂—SiR₂—(O—SiR₂)ₙ—CR²₂—NR⁴—COH—NH—Y—NH—CO]ₐ-[Z-D-CO—NH—Y—NH—CO]_{b}—[NR⁴—CR²₂—SiR₂—(O—SiR₂)ₙ—CR²₂—NR⁴—CO—NH—Y—NH—CO—NH—Y—NH—CO]_{c})_{d}—B,
where
R is a monovalent hydrocarbon or hydrocarbon-oxy radical having 1 to 20 carbon atoms which is unsubstituted or substituted by fluorine or chlorine,
R² is a monovalent hydrocarbon radical having 1 to 20 carbon atoms which is unsubstituted or substituted by fluorine or chlorine, or is hydrogen,
R⁴ is a monovalent hydrocarbon radical having 1 to 20 carbon atoms which is unsubstituted or substituted by fluorine or chlorine, or is hydrogen,
Z is an oxygen atom or an amino group —NR′—,
R′ is hydrogen or an alkyl radical having 1 to 10 carbon atoms,
Y is a divalent hydrocarbon radical having 1 to 20 carbon atoms which is unsubstituted or substituted by fluorine or chlorine,
D is an alkylene radical having 1 to 700 carbon atoms which is unsubstituted or substituted by fluorine, chlorine, C₁-C₆-alkyl or C₁-C₆-alkyl esters and in which nonadjacent methylene units may be replaced by —O—, —COO—, —OCO— or —OCOO— groups,
B is a functional or nonfunctional organic or organosilicon radical,
n is a number from 1 to 4000,
a is a number which is at least 1,
b is a number from 0 to 40,
c is a number from 0 to 30, and
d is a number greater than 0.

Preferably R is a monovalent hydrocarbon radical or hydrocarbon-oxy radical having 1 to 6 carbon atoms, and in particular is unsubstituted. Particularly preferred radicals R are methyl, ethyl, vinyl, phenyl, methoxy, and ethoxy radicals.

Preferably R² and R⁴ are each a monovalent hydrocarbon radical having 1 to 6 carbon atoms, which in particular is unsubstituted, or are each hydrogen. Particularly preferred radicals R² and R⁴ are hydrogen.

Preferably Z is an oxygen atom or an NH group.

Preferably D is an alkylene radical having at least 2, in particular at least 4 carbon atoms and not more than 12 carbon atoms. With further preference D is a polyoxyalkylene radical, especially polyoxyethylene radical or polyoxypropylene radical having at least 20, in particular at least 100 carbon atoms and not more than 800, in particular not more than 200 carbon atoms. Preferably the radical D is unsubstituted.

n is preferably a number which is at least 3, in particular at least 25 and preferably not more than 800, in particular not more than 400, more preferably not more than 250.

Preferably a is a number which is not more than 100.

If b is other than 0, b is preferably a number which is not more than 50, in particular not more than 25.

c is preferably a number which is not more than 10, in particular not more than 5.

The polydiorganosiloxane-urea copolymer of the general formula (1) exhibits good mechanical properties in conjunction with good processing properties.

Surprisingly it has also been found that, when an aminomethyl-terminated polydimethylsiloxane (PDMS) is used, the resultant polyurea-siloxane copolymers are obtained as softer materials than when using aminopropyl-terminated PDMS. This is manifested not only in a lower initial modulus but also in lower Shore hardnesses. It is of advantage in low-modulus sealant applications and also applications where the soft hand of the copolymers is a decisive application criterion, such as is the case in textile applications, for example.

The invention further provides a process for preparing organopolysiloxane/polyurea/polyurethane block copolymers of the general formula (1)
B—{[NR⁴—CR²₂—SiR₂—(O—SiR₂)ₙ—CR²₂—NR⁴—COH—NH—Y—NH—CO]ₐ-[Z-D-CO—NH—Y—NH—CO]_{b}—[NR⁴—CR²₂—SiR₂—(Oₙ—CR²₂—NR⁴—CO—NH—Y—NH—CO—NH—Y—NH—CO]_{c})_{d}—B,
comprising two steps, the first step comprising reacting a silane of the general formula (2)
(R³O)R₂SiCR²₂NHR⁴
with organosilicon compound of the general formula (3),
HO—(R₂SiO)ₙ₋₁H
to give bisaminomethylpolydiorganosiloxane of the general formula (4)
HR⁴N—CR²₂—[SiR₂O]ₙSiR₂—CR²₂—NHR⁴
and the second step comprising polymerizing the bisaminomethylpolydiorganosiloxane of the general formula (4) with diisocyanate of the general formula (5)
OCN—Y—NCO
and if desired water or compounds of the general formula (6)
HZ-D-ZH
as chain extender(s), R, R², R⁴, Z, R′, Y, D, B, n, a, b, c, and d being as defined above, and
R³ being a monovalent hydrocarbon radical having 1 to 20 carbon atoms which is unsubstituted or substituted by fluorine or chlorine, or being hydrogen.

Preferably R³ is a monovalent hydrocarbon radical having 1 to 6 carbon atoms, and in particular is unsubstituted. Particularly preferred radicals R³ are methyl, ethyl or isopropyl groups.

The preparation of the bisaminomethylpolydiorganosiloxane of the general formula (4) is inexpensive, proceeds under mild reaction conditions, and leads to products which are colorless and free from odor. The by-product is an alcohol and can remain in the product, but is preferably removed by treating the product, for example, on a thin-film evaporator under reduced pressure. The amount of cyclic silicone compounds in the bisaminomethylpolydiorganosiloxane of the general formula (4) is particularly low, having been removed right at the stage of the silanol-terminated reactants of the general formula (3). Furthermore, the bisaminomethylpolydiorganosiloxane of the general formula (4) contains neither equilibration catalysts or residues thereof, since the reaction of silanol groups with the aminosilane of the general formula (2) takes place without catalysis within a very short time. Consequently, these functionalized silicone oils and their derivatives are free from odor and are colorless. A further factor is that the polymerization products, owing to the reaction of polyisocyanates, contain a particularly low fraction of cyclic siloxane compounds. Preference is given here to an amount below 2% by weight and particular preference to an amount of <0.5% by weight.

Ideally, in the first step, the silanes of the general formula (2) and the reactants containing silanol groups are used in equimolar proportions, since in that way there is no need to remove excess silane. For this purpose, preferably, the amount of active hydrogen in the silanol-terminated reactant is determined, for example, by titration or spectroscopy in order thus to be able to add an at least equimolar amount of silane. A small amount of residual silanol groups, of up to 5 mol %, in the synthesized aminosilicones, however, can be tolerated for further use. It is preferred, however, to use materials having SiOH contents of less than 1 mol %. Bisaminomethyl-terminated siloxanes of the general formula (4) are obtained in high purity, these compounds being outstandingly suitable for the preparation of high molecular mass siloxane-urea block copolymers.

In order to achieve shorter reaction times in the preparation of high-purity bisaminomethyl-terminated silicones of the general formula (4) it is preferred to use a small excess of the silane of the general formula (2), which can be removed subsequently in a simple additional process step by adding, for example, small amounts of water or by distillation. This reaction can be carried out either at room temperature or with heating. Through the use of chain extenders such as dihydroxy compounds or water in addition to the urea groups it is possible, furthermore, to achieve a distinct improvement in mechanical properties. For instance, materials can be obtained which in terms of their mechanical properties are entirely comparable with conventional silicone rubbers and yet have a heightened transparency, with no need to incorporate any additional active filler.

The chain extenders preferably have the general formula (6)
HZ-D-ZH,
where D and Z have the above definitions. If Z has the definition O, the chain extender of the general formula (6) can also be reacted prior to the reaction in the second step with diisocyanate of the general formula (5).

Examples of the diisocyanates of the general formula (5) that are to be used are aliphatic compounds such as isophorone diisocyanate, hexamethylene 1,6-diisocyanate, tetramethylene 1,4-diisocyanate and methylenedicyclohexyl 4,4′-diisocyanate or aromatic compounds such as methylenediphenyl 4,4′-diisocyanate, toluene 2,4-diisocyanate, toluene 2,5-diisocyanate, toluene 2,6-diisocyanate, m-phenylene diisocyanate, p-phenylene diisocyanate, m-xylene diisocyanate, tetramethyl-m-xylene diisocyanate or mixtures of these isocyanates. An example of commercially available compounds are the diisocyanates of the DESMODUR® series (H, I, M, T, W) from Bayer AG, Germany. Preference is given to aliphatic diisocyanates in which Y is a (cyclo-)alkylene radical, since these materials exhibit improved UV stabilities, which is of advantage where the polymers are used outdoors.

The α,ω-OH-terminated alkylenes of the general formula (6) are preferably polyalkylenes or polyoxyalkylenes. They are preferably largely free from contaminations from polyoxyalkylenes with a functionality of one or three or more. In this context it is possible to use polyetherpolyols, polytetramethylenediols, polyesterpolyols, polycaprolactonediols, or else α,ω-OH-terminated polyalkylenes based on polyvinyl acetate, or polyvinyl acetate-ethylene copolymers, polyvinyl chloride copolymer, and polyisobutyldiols. Preference is given to using polyoxyalkyls, more preferably polypropylene glycols. Compounds of this kind are available commercially as base materials, inter alia, for flexible polyurethane foams and for coating applications, with molecular masses Mn of up to more than 10,000. Examples thereof are the BAYCOLL® polyetherpolyols and polyesterpolyols from Bayer AG, Germany, or the Acclaim® polyetherpolyols from Lyondell Inc., USA. It is also possible to use monomeric α,ω-alkylenediols, such as ethylene glycol, propanediol, butanediol or hexanediol. Furthermore, dihydroxy compounds for the purposes of the invention likewise comprehend bishydroxyalkylsilicones, such as are sold, for example, by Goldschmidt under the name Tegomer H—Si 2111, 2311, and 2711.

The above-described copolymers of the general formula (1) can be prepared either in solution or else in bulk (without solvent), continuously or batchwise. What is essential is that, for the chosen polymer mixture under the reaction conditions, optimum and homogeneous commixing of the constituents takes place and any phase incompatibility is prevented where necessary by means of solubilizers. The preparation depends on the solvent used. Where the fraction of the hard segments such as urethane units or urea units is large, then it is necessary if appropriate to choose a solvent having a high solubility parameter such as, for example, dimethylacetamide. For the majority of syntheses, THF has proven adequately suitable. Preferably, all of the constituents are dissolved in an inert solvent. Particular preference is given to a synthesis without solvent.

For the reaction without solvent, homogenizing the mixture is of critical importance to the reaction. Furthermore, the polymerization can also be controlled through the choice of the reaction sequence in the case of a staged synthesis. Here it is common to use heated reactors such as extruders, for example. In this case it should be ensured that the oxygen content in the reaction mixture to be extruded, or its components, is as low as possible, in order to avoid any yellowing of the polymer.

Accordingly, for better reproducibility, the preparation ought generally to take place in the absence of moisture and under inert gas, usually nitrogen or argon.

The reaction takes place preferably—as usual for the preparation of polyurethanes—by addition of a catalyst. Suitable catalysts for the preparation are dialkyltin compounds, such as dibutyltin dilaurate or dibutyltin diacetate, for example, or tertiary amines, such as N,N-dimethylcyclohexanamine, 2-dimethylaminoethanol or 4-dimethylaminopyridine, for example.

Preferred applications of the polydiorganosiloxane-urea copolymers of the general formula (1) are uses as a constituent in adhesives and sealants, as base material for thermoplastic elastomers such as, for example, cable sheathing, hoses, seals, keyboard mats, for membranes, such as membranes possessing selective gas permeability, as additives to polymer blends, or for coating applications, such as in antistick coatings, tissue-compatible coatings, and flame-retarded coatings, and as biocompatible materials. Further application possibilities are sealants, additives for polymer processing, antifouling coatings, cosmetics, bodycare products, coatings additives, an auxiliary in laundry detergents and textile finishing, for modifying resins or for bitumen modification. The use of these thermoplastic materials is conceivable in numerous applications: in sealants, adhesives, as material for fibers, as a plastics additive, e.g., as impact modifiers or flame retardants, as material for defoamer formulations, as a high-performance polymer (thermoplastic, thermoplastic elastomer, elastomer), as packaging material for electronic components, in insulating or shielding materials, in cable sheathing, in antifouling materials, as an additive for cleaning, cleansing or polishing products, as an additive for bodycare products, as coating material for wood, paper, and cardboard, as a mold release agent, as a biocompatible material in medical applications such as contact lenses, as coating material for textile fibers or textile fabrics, as coating material for natural substances such as leather and furs, for example, as material for membranes, and as material for photoactive systems, for lithographic processes, optical data protection or optical data transfer, for example.

All of the above symbols in the above formulae have their definitions in each case independently of one another.

In the examples below, unless indicated otherwise in each specific case, all amounts and percentages are by weight and all pressures are 0.10 MPa (abs.). All viscosities were determined at 20° C. The molecular masses were determined by means of GPC in toluene (0.5 ml/min) at 23° C. (column: PLgel Mixed C+PLgel 100 A, detector: RI ERC7515). The softening ranges were determined by means of thermomechanical analysis (TMA).

### EXAMPLE 1

A 2000-ml flask with dropping funnel and reflux condenser was charged with 1500 g of bishydroxy-terminated polydimethylsiloxane having a molecular weight of 3150 g/mol. Subsequently at room temperature 116 g of aminomethyldimethylmethoxysilane were added dropwise and the mixture was then left to stand for 2 hours. Subsequently the methanol by-product was stripped off under reduced pressure. This gave a bisaminomethyl-terminated polydimethylsiloxane having a molecular weight of 3280 g/mol, which according to ²⁹Si NMR was free of Si—OH groups.

### EXAMPLE 2

A 2000-ml flask with dropping funnel and reflux condenser was charged with 1080 g of bishydroxy-terminated polydimethylsiloxane having a molecular weight of 10,800 g/mol. Subsequently at a temperature of 60° C. 23.6 g of aminomethyldimethylmethoxysilane were added dropwise and the mixture was then stirred at 60° C. for 5 hours, with methanol formed being stripped off from the reaction mixture under a slight reduced pressure. Cooling gave a bisaminomethyl-terminated polydimethylsiloxane having a molecular weight of 11,000 g/mol, which according to ²⁹Si NMR was free of Si—OH groups.

### EXAMPLE 3

A 250-ml flask with dropping funnel and reflux condenser was charged with 40 g of bisaminomethyl-terminated PDMS (Example 1, molecular weight 3280 g/mol) in a solvent mixture of 80 ml of dry THF and 20 ml of dimethylacetamide. Subsequently at room temperature a solution of 2.33 g of methylene di-p-phenyl diisocyanate in 20 ml of dry THF was added dropwise, after which the mixture was boiled under reflux for 1 hour. After the solution had cooled, the polymer was precipitated by blockwise introduction into hexane. This gave a polymer which in the TMA showed a softening range at 144° C.

### EXAMPLES 4-9 (NOT INVENTIVE)

In the same way as in Example 3 a bisaminopropyl-terminated PDMS having a molecular weight of 3280 g/mol) (analogous to Example 1) or 11,000 g/mol (analogous to Example 2) was reacted with the diisocyanates isophorone diisocyanate (IPDI), hexamethylene 1,6-diisocyanate (HMDI), tetramethylene 1,4-diisocyanate (TDI), tetramethyl-m-xylene diisocyanate (TMXDI) or methylenebis(4-isocyanatocyclohexane) (H12MDI).

| | Molecular | | | |
|---|---|---|---|---|
| | weight | | | Softening |
| | amine oil | | Yield | range TMA |
| Example | [g/mol] | Diisocyanate | [%] | [° C.] |
| 4 | 3280 | IPDI | 98 | 56 |
| 5 | 3280 | HMDI | 94 | 47 |
| 6 | 3280 | TDI | 93 | 110 |
| 7 | 3280 | TMXDI | 95 | not |
| | | | | determined |
| 8 | 3280 | H12MDI | 92 | 101 |
| 9 | 11,000 | MDI | 91 | not |
| | | | | determined |
| 10 | 11,000 | IPDI | 88 | not |
| | | | | determined |
| 11 | 11,000 | TDI | 93 | not |
| | | | | determined |
| 12 | 11,000 | H12MDI | 93 | not |
| | | | | determined |

### EXAMPLE 13

In a twin-screw extruder from Collin, Ebersberg, Germany, with 6 heating zones, under a nitrogen atmosphere, the diisocyanate was metered into the first heating zone and the aminomethyl-terminated silicone oil with a molecular weight of 3280 g/mol from Example 1 was metered into the second heating zone. The temperature profile of the heating zones was programmed as follows: zone 1 45° C., zone 2 100° C., zone 3 150° C., zone 4 140° C., zone 5 140° C., zone 6 130° C. The rotation speed was 50 rpm. The diisocyanate (methylenebis(4-isocyanatocyclohexane)) was metered in in zone 1 at 304 mg/min and the bisaminomethyl-terminated silicone oil was metered in in zone 2 at 3.5 g/min. Taken off from the die of the extruder was a polydimethylsiloxane-polyurea block copolymer having a softening temperature of 105° C.

### EXAMPLE 14

In the same way as in Example 13, in a twin-screw extruder from Collin, Ebersberg, Germany, with 6 heating zones, under a nitrogen atmosphere, with a temperature profile (zone 1 30° C., zone 2 90° C., zone 3 120° C., zone 4 130° C., zone 5 100° C., zone 6 80° C., rotational speed=50 rpm), isophorone diisocyanate (IPDI) was metered in in zone 1 at 179 mg/min and the bisaminomethyl-terminated silicone oil with a molecular weight of 3280 g/mol from Example 1 was metered in in zone 2 at 3.5 g/min. Taken off from the die of the extruder was a polydimethylsiloxane-polyurea block copolymer having a softening temperature of 58° C.

### EXAMPLE 15

In the same way as in Example 13, in a twin-screw extruder from Collin, Ebersberg, Germany, with 6 heating zones, under a nitrogen atmosphere, with a temperature profile (zone 1, 30° C.; zone 2, 100° C.; zone 3, 170° C.; zone 4, 180° C.′ zone 5, 160° C.; zone 6, 130° C.; rotational speed=50 rpm), toluene 2,4-diisocyanate (TDI) was metered in in zone 1 at 111 mg/min and the bisaminomethyl-terminated silicone oil with a molecular weight of 11,000 g/mol was metered in in zone 2 at 5.2 g/min. Taken off from the die of the extruder was a polydimethylsiloxane-polyurea block copolymer having a softening temperature of 107° C.

### EXAMPLE 16

A 250-ml flask with dropping funnel and reflux condenser was charged with 32 g of bisaminomethyl-terminated PDMS having a molecular weight of 3280 g/mol from Example 1 and 5 g of bishydroxypropyl-PDMS (Tegomer 2711, Th. Goldschmidt AG) having a molecular weight of 5200 g/mol in a solvent mixture of 80 ml of dry THF and 20 ml of dimethylacetamide. Following the addition of 3 drops of dibutyltin dilaurate, a solution of 2.5 g of isophororone diisocyanate (IPDI) in 20 ml of dry THF was added dropwise at room temperature, followed by boiling under reflux for 2 hours. After the solution had cooled, the polymer was precipitated by dropwise introduction into hexane. This gave a copolymer having a molecular weight of 78,000 g/mol and a softening point at 42° C.

### EXAMPLE 17

A 250-ml flask with dropping funnel and reflux condenser was charged with 32 g of bisaminomethyl-terminated PDMS having a molecular weight of 3280 g/mol and 0.9 g of butanediol in a solvent mixture of 80 ml of dry THF and 20 ml of dimethylacetamide. Following the addition of 3 drops of dibutyltin dilaurate, a solution of 4.5 g of isophororone diisocyanate (IPDI) in 20 ml of dry THF was added dropwise at room temperature, followed by boiling under reflux for 2 hours. After the solution had cooled, the polymer was precipitated by dropwise introduction into hexane. This gave a copolymer having a molecular weight of 63,000 g/mol.

### COMPARATIVE EXAMPLE 18 (NOT INVENTIVE)

In a twin-screw extruder from Collin, Ebersberg, Germany, with 6 heating zones, under a nitrogen atmosphere, methylenebis(4-isocyanatocyclohexane) (H12MDI) was metered into the first heating zone and an aminopropyl-terminated silicone oil (prepared by equilibration in accordance with EP 0 250 248, molecular weight 3250 g/mol) was metered into the second heating zone. The temperature profile of the heating zones was programmed as follows: zone 1, 30° C.′ zone 2, 100° C.; zone 3, 150° C.; zone 4, 180° C.; zone 5, 170° C.; zone 6, 140° C. The rotation speed was 50 rpm. The diisocyanate was metered in in zone 1 at 304 mg/min and the amine oil (3250 g/mol) was metered in in zone 2 at 3.5 g/min. Taken off from the die of the extruder was a polydimethylsiloxane-polyurea block copolymer having a softening temperature of 133° C.

### COMPARATIVE EXAMPLE 19 (NOT INVENTIVE)

In the same way as in Example 13, in a twin-screw extruder from Collin, Ebersberg, Germany, with 6 heating zones, under a nitrogen atmosphere, with a temperature profile (zone 1, 30° C.; zone 2, 100° C.; zone 3, 170° C.; zone 4, 160° C.; zone 5, 130° C.; zone 6, 130° C.; rotational speed=50 rpm), isophorone diisocyanate (IPDI) was metered in in zone 1 at 179 mg/min and an aminopropyl-terminated silicone oil (prepared by equilibration in accordance with EP 0 250 248, molecular weight 3250 g/mol) was metered in in zone 2 at 3.5 g/min. Taken off from the die of the extruder was a polydimethylsiloxane-polyurea block copolymer having a softening temperature of 110° C.

| | | | Soft- | | | | |
|---|---|---|---|---|---|---|---|
| | | | ening | | 100% | | |
| Ex- | | Diiso- | range | Shore | modulus | | |
| ample | Type | cyanate | [° C.] | A | [MPa] | Odor | Color |
| 13 | Amino- | H12MDI | 105 | 31 | 0.7 | weak | trans- |
| | methyl | | | | | | parent, |
| | | | | | | | color- |
| | | | | | | | less |
| 14 | Amino- | IPDI | 60 | 25 | 0.5 | weak | trans- |
| | methyl | | | | | | parent, |
| | | | | | | | color- |
| | | | | | | | less |
| 18 | Amino- | H12MDI | 133 | 39 | 1.1 | pung- | trans- |
| | propyl | | | | | ent | parent, |
| | | | | | | | yellow |
| 19 | Amino- | IPDI | 110 | 33 | 0.7 | pung- | trans- |
| | propyl | | | | | ent | parent, |
| | | | | | | pale | |
| | | | | | | | yellow |

It is apparent that, with the isocyanate constant, the materials based on the aminomethyl-terminated PDMS have lower softening ranges, a lower 100% modulus, lower Shore A hardnesses, a lower intrisic color, and a lower intrinsic odor.

What is claimed is:

1. An organopolysiloxane/polyurea/polyurethane block copolymer of the formula (1)
B—{[NR⁴—CR²₂—SiR²—(O—SiR₂)ₙ—CR²₂—NR⁴—COH—NH—Y—NH—CO]ₐ-[Z-D-CO—NH—Y—NH—CO]_{b}—[NR⁴—CR²₂—SiR₂—(O—SiR₂)ₙ—CR²₂—NR⁴—CO—NH—Y—NH—CO—NH—Y—NH—CO]_{c})_{d}—B,
where
R is a monovalent hydrocarbon or hydrocarbon-oxy radical having 1 to 20 carbon atoms which is unsubstituted or substituted by fluorine or chlorine,
R² is a monovalent hydrocarbon radical having 1 to 20 carbon atoms which is unsubstituted or substituted by fluorine or chlorine, or is hydrogen,
R⁴ is a monovalent hydrocarbon radical having 1 to 20 carbon atoms which is unsubstituted or substituted by fluorine or chlorine, or is hydrogen,
Z is an oxygen atom or an amino group —NR′—,
R′ is hydrogen or an alkyl radical having 1 to 10 carbon atoms,
Y is a divalent hydrocarbon radical having 1 to 20 carbon atoms which is unsubstituted or substituted by fluorine or chlorine,
D is an alkylene radical having 1 to 700 carbon atoms which is unsubstituted or substituted by fluorine, chlorine, C₁-C₆-alkyl or C₁-C₆-alkyl esters and in which nonadjacent methylene units are optionally replaced by —O—, —COO—, —OCO— or —OCOO— groups,
B is a functional or nonfunctional organic or organosilicon radical,
n is a number from 1 to 4000,
a is a number which is at least 1,
b is a number from 0 to 40,
c is a number from 0 to 30, and
d is a number greater than 0.

2. The organopolysiloxane/polyurea/polyurethane block copolymer of claim 1, wherein R is a monovalent hydrocarbon radical or hydrocarbon-oxy radical having 1 to 6 carbon atoms.

3. The organopolysiloxane/polyurea/polyurethane block copolymer of claim 1, wherein R is individually a monovalent, unsubstituted hydrocarbon radical selected from the group consisting of methyl, ethyl, vinyl, phenyl, methoxy, and ethoxy radicals.

4. The organopolysiloxane/polyurea/polyurethane block copolymer of claim 1, wherein, R² and R⁴ independently of one another, are monovalent hydrocarbon radicals having 1 to 6 carbon atoms.

5. The organopolysiloxane/polyurea/polyurethane block copolymer of claim 1, wherein R² and R⁴ are each hydrogen.

6. The organopolysiloxane/polyurea/polyurethane block copolymer of claim 1, wherein D is an alkylene radical having at least 2 carbon atoms and not more than 12 carbon atoms.

7. The organopolysiloxane/polyurea/polyurethane block copolymer of claim 1, wherein D individually is a polyoxyalkylene radical selected from the group consisting of polyoxyethylene radicals and polyoxypropylene radicals having at least 20 and not more than 800 carbon atoms.

8. The organopolysiloxane/polyurea/polyurethane block copolymer of claim 1, wherein n is a number from 3 to 800.

9. The organopolysiloxane/polyurea/polyurethane block copolymer of claim 1, wherein n is a number from 25 to 250.

10. The organopolysiloxane/polyurea/polyurethane block copolymer of claim 1, wherein a is a number which is not more than 100 and c is a number which is not more than 10.

11. The organopolysiloxane/polyurea/polyurethane block copolymer of claim 1, wherein b is a number from 1 to 25.

12. The organopolysiloxane/polyurea/polyurethane block copolymer of claim 1, wherein c is a number which is not more than 5.

13. A process for preparing an organopolysiloxane/polyurea/polyurethane block copolymer of claim 1, comprising at least two steps, a first step comprising reacting at least one silane of the formula (2)
(R³O)R₂SiCR²₂NHR⁴
with at least one organosilicon compound of the formula (3),
HO—(R₂SiO)ₙ₋₁H
to give a bisaminomethylpolydiorganosiloxane of the formula (4)
HR⁴N—CR²₂—[SiR₂O]ₙSiR₂—CR²₂—NHR⁴
and a second step comprising polymerizing the bisaminomethylpolydiorganosiloxane of the general formula (4) with at least one diisocyanate of the formula (5)
OCN—Y—NCO
and optionally, water or one or more compounds of the formula (6)
HZ-D-ZH
as chain extender(s), where
R is a monovalent hydrocarbon or hydrocarbon-oxy radical having 1 to 20 carbon atoms which is unsubstituted or substituted by fluorine or chlorine,
R² is a monovalent hydrocarbon radical having 1 to 20 carbon atoms which is unsubstituted or substituted by fluorine or chlorine, or is hydrogen,
R³ is a monovalent hydrocarbon radical having 1 to 20 carbon atoms which is unsubstituted or substituted by fluorine or chlorine, or is hydrogen,
R⁴ is a monovalent hydrocarbon radical having 1 to 20 carbon atoms which is unsubstituted or substituted by fluorine or chlorine, or is hydrogen,
Z is an oxygen atom or an amino group —NR′—,
R′ is hydrogen or an alkyl radical having 1 to 10 carbon atoms,
Y is a divalent hydrocarbon radical having 1 to 20 carbon atoms which is unsubstituted or substituted by fluorine or chlorine,
D is an alkylene radical having 1 to 700 carbon atoms which is unsubstituted or substituted by fluorine, chlorine, C₁-C₆-alkyl or C₁-C₆-alkyl esters and in which nonadjacent methylene units are optionally replaced by —O—, —COO—, —OCO— or —OCOO— groups,
B is a functional or nonfunctional organic or organosilicon radical,
n is a number from 1 to 4000,
a is a number which is at least 1,
b is a number from 0 to 40,
c is a number from 0 to 30, and
d is a number greater than 0.

14. The process of claim 13, wherein in the first step the silanes of the formula (2) are added in at least equimolar amount.

15. The process of claim 14, wherein excess silane of the formula (2) is removed by adding water or by distillation before the second step.

16. The process of claim 14, wherein a dihydroxy compound of the formula (6) and/or water are added as chain extender(s) in the second step.

17. The process of claim 13, wherein at least one diisocyanate is an aliphatic or aromatic compound selected from the group consisting of isophorone diisocyanate, hexamethylene 1,6-diisocyanate, tetramethylene 1,4-diisocyanate, methylenedicyclohexyl 4,4′-diisocyanate, methylenediphenyl 4,4′-diisocyanate, toluene 2,4-diisocyanate, toluene 2,5-diiso-cyanate, toluene 2,6-diisocyanate, m-phenylene diisocyanate, p-phenylene diisocyanate, m-xylene diisocyanate, and tetramethyl-m-xylene diisocyanate.

18. The process of claim 13, wherein α,ω-OH-terminated alkylenes of the general formula (6) are polyalkylenes or polyoxyalkylenes selected from the group con-sisting of polyetherpolyols, polytetramethylenediols, polyesterpolyols, polycaprolactonediols, α,ω-OH-terminated polyalkylenes based on polyvinyl acetate, and polyvinyl acetate-ethylene copolymers, polyvinyl chloride copolymer, and polyisobutyldiols.

19. The process of claim 13, wherein the α,ω-OH-terminated alkylenes of the formula (6) are monomeric α,ω-alkylenediols selected from the group consisting of ethylene glycol, propanediol, butanediol, and hexanediol.

20. The process claim 13, wherein the α,ω-OH-terminated alkylenes of the formula (6) are bishydroxyalkylsilicones.

21. The process of claim 13, wherein the process takes place in the absence of moisture and under inert gas.

22. The process of claim 13, wherein at least one catalyst is selected from the group consisting of dialkyltin compounds, dibutyltin dilaurate or dibutyltin diacetate, tertiary amines, N,N-dimethylcyclohexanamine, 2-dimethylaminoethanol, and 4-dimethylaminopyridine is employed.
